(19) United States
(12) Patent Application Publication
(10) Pub. No.: US 2020/0066177 A1
(43) Pub. Date: Feb. 27, 2020

(54) MULTI-VIEW DISPLAY DEVICE AND MANIPULATION SIMULATION DEVICE

(71) Applicant: Industrial Technology Research Institute, Hsin-Chu (TW)

(72) Inventors: JUNG-YU LI, Hsinchu County (TW); SHIH-PU CHEN, Hsinchu City (TW); YI-PING LIN, Hsinchu City (TW); HONG-HUI HSU, Hsinchu County (TW); MEI-TAN WANG, Miaoli County (TW)

(21) Appl. No.: 16/548,956

(22) Filed: Aug. 23, 2019

Related U.S. Application Data
(60) Provisional application No. 62/722,459, filed on Aug. 24, 2018.

(30) Foreign Application Priority Data
Jun. 14, 2019 (TW) 108120688

(51) Int. Cl. G09B 9/02; G09G 5/14; H04N 9/31; G02B 27/22

(52) U.S. Cl. CPC G09B 9/02; G09G 5/14; G09B 9/05; G02B 27/2214; H04N 9/31

(57) ABSTRACT

A multi-view display device includes a display screen component and an optical structure component. The display screen component includes a plurality of pixels, and each of the plurality of pixels includes a left sub-pixel and a right sub-pixel. The optical structure component is disposed at the display screen component. When light beams from the left sub-pixel and light beams from the right sub-pixel of the each of the plurality of pixels pass through the optical structure component, the optical structure component separates the light beams from the left sub-pixel and the light beams from the right sub-pixel so as to generate correspondingly a left image and a right image to reach the first pilot position and the second pilot position, respectively. In addition, a manipulation simulation device is also provided.

### CROSS REFERENCE TO RELATED APPLICATION

This application claims the benefits of U.S. provisional application Ser. No. 62/722,459, filed on Aug. 24, 2018, and Taiwan application Serial No. 108120688, filed on Jun. 14, 2019, the disclosures of which are incorporated by references herein in its entirety.

### TECHNICAL FIELD

The present disclosure relates in general to a manipulation simulation device, and more particularly to a multi-view display device applied to the manipulation simulation device.

### BACKGROUND

A flight simulator is a training equipment that can simulate a virtual flight on the ground, and thus is one of necessary equipment for training pilots in aviation companies or in military. In particular, a visual system of the flight simulator, mainly in charge of creating a virtual visual field surrounding the pilot cabin, provides virtual visual and position environments for the trainee or the pilots inside the training cabin to simulate or experience. In a modern airplane, at least two pilots, one captain and one associate captain, are needed to cooperate a unique flight, and thus, for safety assurance, both of the pilots in the pilot cabin shall be provided with correct-angling surrounding visual fields outside the cabin.

According to different stages of a complete flight training program, the simulation equipments are specifically named and used as a beginner-level flight training device (FTD), a middle-level fixed based simulator (FBS) and a high-level full flight simulator (FFS). In both of the foregoing FFS and FBS, the visual system shall be one of the collimated projection vision systems. Theoretically, a typical projection vision system utilizes a convex lens to reflect a rear image of a projection cabin, and to image at an infinite-far position, such that light beams from the image can present a collimation effect. However, the conventional collimated projection vision system has a shortcoming of decaying image intensity. Namely, the created image would present a major difference to a real object under outdoor lights. Thus, the conventional collimated projection vision system, featured in lower brightness, would degrade the exterior visual fidelity. Thereupon, in a simulation of daylight flight, a sense of moonlight would be felt inside the simulator cabin. Such a situation would make big differences between the simulator flight and a real flight. In particular, the simulator is usually unable to provide a simulation of outdoor bright lights entering the cabin. In addition, the conventional collimated projection vision system needs periodical shutdown maintenance, from which the equipment expense would be increased, but the operation hours would be lowered.

The visual system of the flight training system generally utilizes an abutted image generated from an abetted display screen or several projecting devices. In other words, in comparison with the FBS and the FFS, structuring cost for the visual system of flight procedures and operational training simulations for the FTD is less expensive, but a center of the front screen of the FTD visual system is fallen right at a middle position between two pilot seats. Thus, for these two pilots, visual deviations are inevitable. Namely, the visual system can be only suitable to a system for training one single pilot, and not suitable to another system for training simultaneously dual or multiple pilots. Obviously, such a simulation setup is different to the real flight.

### SUMMARY

In this disclosure, a manipulation simulation device and a multi-view display device are provided to generate at least two independent images for corresponding operators, so that respective and correct visual fields can be purposely provided to the two operators.

According one embodiment of this disclosure, the multi-view display device, applicable to connect a manipulation simulation device including a first pilot position and a second pilot position, includes a display screen component and an optical structure component. The display screen component includes a plurality of pixels, and each of the plurality of pixels includes a left sub-pixel and a right sub-pixel. The optical structure component is disposed at the display screen component. When light beams from the left sub-pixel and light beams from the right sub-pixel of the each of the plurality of pixels pass through the optical structure component, the optical structure component separates the light beams from the left sub-pixel and the light beams from the right sub-pixel so as to generate correspondingly a left image and a right image to reach the first pilot position and the second pilot position, respectively.

In one embodiment of this disclosure, a manipulation simulation device is provided to include a simulator cabin, a control platform and the multi-view display device. The simulator cabin includes a pilot area having a first pilot position and a second pilot position. The control platform, disposed in the simulator cabin, is used for providing at least one image information, independent to each other. The multi-view display device is connected with the simulator cabin and also the control platform. The multi-view display device includes a display screen component and an optical structure component. The display screen component includes a plurality of pixels, and each of the plurality of pixels includes a left sub-pixel and a right sub-pixel. The optical structure component is disposed at the display screen component. When light beams from the left sub-pixel and light beams from the right sub-pixel of the each of the plurality of pixels pass through the optical structure component, the optical structure component separates the light beams from the left sub-pixel and the light beams from the right sub-pixel so as to generate correspondingly a left image and a right image to reach the first pilot position and the second pilot position, respectively.

As stated, in the manipulation simulation device and multi-view display device provided by this disclosure, an environment with the field of vision (FOV) larger than 180° is created, and the optical structure component is introduced to separate light beams from the left sub-pixel and the right sub-pixel of the same pixel so as to generate the corresponding left image and right image to reach the first pilot position and the second pilot position, respectively. Thereupon, the display screen of the same display screen component can generate multiple independent images without mutual interference. These independent images would be transmitted to different view locations at the first pilot position and the second pilot position, so that pilots at different view locations at the first pilot position and the second pilot position can still have the same visual field, correctly and independently. Hence, different operators or pilots at the first pilot position 51 and the second pilot position 52 with respective front view angles can have a collimated visual field, without any error angle, and thus a flight training program toward a multi crew pilot license (MPL) can be provided.

In addition, the display screen component can be an LED display. Since the LED pixel can have its own light source to control brightness, thus brightness on a specific screen can be controlled for demonstrating significant imaging difference between a target object and the surrounding on the screen so as to simulate a practical event, upon when the target object irradiates bright lights such as sunlight or the like lamp-light. Further, for the LED pixel can provide brighter lights to simulate the glare phenomenon caused by natural lights such as daylights or lamp-lights outside the flight simulator, thus quality images and simulated sun lights can be obtained.

In addition, in this disclosure, since multiple sets of independent image information are provided to pair the multi-view display device, and each of the sets of image information is to organize correct exterior visual fields for different pilots at different pilot positions, thus individual pilots at different pilot position can still have images with the same visual field.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1A is a schematic view of an embodiment of the multi-view display device in accordance with this disclosure;

FIG. 1B is a schematic view of another embodiment of the multi-view display device in accordance with this disclosure;

FIG. 2 is a schematic view of an embodiment of the optical structure component in accordance with this disclosure;

FIG. 3 is a schematic view of an application of the optical structure component of FIG. 2 on the multi-view display device;

FIG. 4 is a schematic view of another embodiment of the optical structure component in accordance with this disclosure;

FIG. 5 is a schematic view of a further embodiment of the optical structure component in accordance with this disclosure;

FIG. 6A to FIG. 6C are schematic views of more embodiments of the optical structure component in accordance with this disclosure;

FIG. 7 is a schematic view showing controls of emission angles of the left sub-pixels and the right sub-pixels of FIG. 1;

FIG. 8 is a schematic view of an embodiment of the manipulation simulation device in accordance with this disclosure;

FIG. 9 is a schematic view of an embodiment of the image information in accordance with this disclosure; and

FIG. 10 is a schematic view of another embodiment of the image information in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In this disclosure, the term “multi-view display device” is defined as an electronic device or display system that can provide independent images without mutual interfere to the same display screen, these independent images can be correspondent to different view locations, and the same visual field can be observed at different view locations (even under different visual environments). In addition, in this disclosure, the wording “multi-view” in the aforesaid term “multi-view display device” is definitely directed to the scenery that includes at least two independent images.

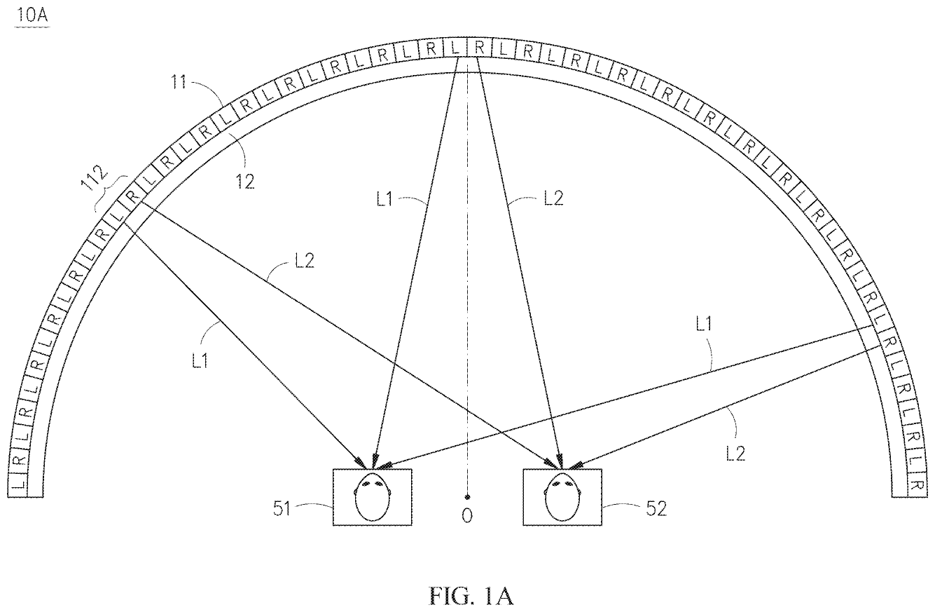

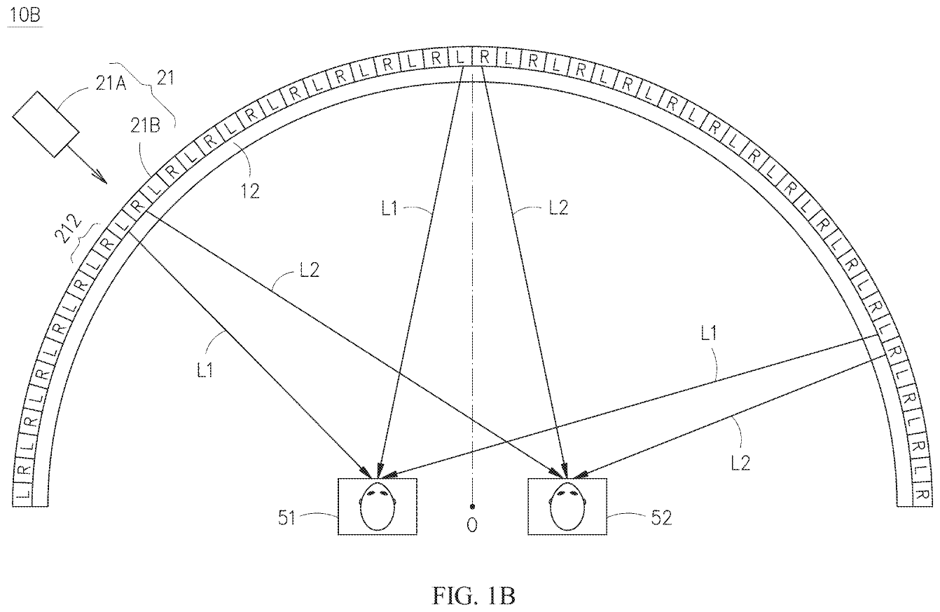

Referring now to FIG. 1A, a schematic view of an embodiment of the multi-view display device in accordance with this disclosure is shown. In this embodiment, the multi-view display device 10A is suitable for connecting a manipulation simulation device, and the manipulation simulation device can be applied to simulate a plane, a ship, a vehicle or a train. In this embodiment, the manipulation simulation device is a flight simulator, and the multi-view display device 10A is a visual simulator for the flight simulator that can provide visual fields outside the pilot cabin to two pilots so as to create a virtual environment to train the pilots. The manipulation simulation device includes a reference position O, a first pilot position 51 and a second pilot position 52. The reference position O is located between the first pilot position 51 and the second pilot position 52.

In this embodiment, the multi-view display device 10A includes a display screen component 11 and an optical structure component 12, in which the optical structure component 12 is a 3D optical film. By having FIG. 1A as an example, the display screen component 11 can be, but not limited to, a ring screen. In some other embodiments, the display screen component can be a curved screen or a spherical screen. The display screen component 11 includes a plurality of pixels 112, and each of the pixels 112 includes a left sub-pixel Land a right sub-pixel R. In this embodiment, the optical structure component 12 and the display screen component 11 are independent structures, but the optical structure component 12 is disposed on the display screen component 11. Yet, the arrangement of the optical structure component 12 with respect to the display screen component 11 is not limited to the aforesaid embodiment. In some other embodiments, the display screen component 11 can be divided into a plurality of modular screens, and each of the modular screens is paired by an optical structure component 12 with a relevant size. By providing the modular screens, a display screen with a wide visual field can be achieved.

Under the aforesaid arrangement constructed basically with the ring screen, a visual environment whit a field of vision (FOV) larger than 180° can be established. In each of the pixels 112, a pair of a left sub-pixel L and a right sub-pixel R are included. The light beams from the left sub-pixel L and the light beams from the right sub-pixel R are sent through the optical structure component 12, respectively. The optical structure component 12 separates the light beams from the left sub-pixel L and the light beams from the right sub-pixel R in each of the pixels 112, so that the light beams from the left sub-pixel L and the light beams from the right sub-pixel R can generate correspondingly a left image L1 and a right image L2 at a first pilot position 51 and a second pilot position 52, respectively. Thereupon, multiple images, independently without mutual interference, can be formed simultaneously on the display screen of the same display screen component 11. These independent images are sent to different view locations at the first pilot position 51 and the second pilot position 52, so that different pilots at the first pilot position 51 and the second pilot position 52 can obtain independent and correct visual fields. Hence, different operators or pilots at the first pilot position 51 and the second pilot position 52 with respective front view angles can have a collimated visual field, without any error angle, and thus a flight training program toward a multi crew pilot license (MPL) can be provided.

In addition, in this embodiment, the display screen component 11 is a curved LED display having a curved screen to provide a pixel 112 with a 3D display effect. Further, by providing a blocking structure or a grating structure to each of the LED pixels 112, or by providing in-depth calculations to each of the LED pixels 112, then a 3D imaging effect can be obtained. In this embodiment, since the images are directly generated by the pixels 112 of the display screen component 11, and further since the LED pixel 112 itself can be a light source with controllable brightness, thus brightness on a specific screen can be controlled for demonstrating significant imaging difference between a target object and the surrounding on the screen so as to simulate a practical event, upon when the target object irradiates bright lights such as sunlight or the like lamp-light. Further, for the LED pixel can provide brighter lights to simulate the glare phenomenon caused by natural lights such as daylights or lamp-lights outside the flight simulator, thus quality images to meet such events can be obtained. In some other embodiments, the display screen component 11 can be a curved LED display, an organic LED display (OLED), a liquid crystal display (LCD) or a combination of at least two of the aforesaid displays.

Referring now to FIG. 1B, a schematic view of another embodiment of the multi-view display device in accordance with this disclosure is shown. Firstly, it shall be explained that the multi-view display device 10A in FIG. 1B is largely resembled to that in FIG. 1A, thus elements with the same functions will be assigned by the same numbers, and details thereabout would be omitted. Namely, only differences between FIG. 1A and FIG. 1B would be provided in the following description. The major difference between FIG. 1B and FIG. 1A is that, in this embodiment of FIG. 1B, the display screen component 21 is a rear projecting device. This rear projecting device 21 includes a projecting device 21A and a projection screen 21B. The projection screen 21B includes a plurality of pixels 212. The projecting device 21A is introduced to generate 3D images onto the projection screen 21B and the corresponding pixels 212. Each of the pixels 212 includes a left sub-pixel Land a right sub-pixel R. In addition, by having FIG. 1B as an example, the projection screen 21B can be, but not limited to, a ring screen. That is, in some other embodiments, the projection screen can be a curved screen or a spherical screen.

Under the aforesaid arrangement constructed basically with the ring screen, a visual environment whit a field of vision (FOV) larger than 180° can be established. To meet the change of the display screen component 21 to be embodied as the rear projecting device in this embodiment, in each of the pixels 112 having a pair of a left sub-pixel L and a right sub-pixel R, the light beams from the left sub-pixel L and the light beams from the right sub-pixel R are sent through the optical structure component 12, respectively. The optical structure component 12 separates the light beams from the left sub-pixel L and the light beams from the right sub-pixel R in each of the pixels 112, so that the light beams from the left sub-pixel L and the light beams from the right sub-pixel R can generate correspondingly a left image L1 and a right image L2 at a first pilot position 51 and a second pilot position 52, respectively. Thereupon, different operators or pilots at the first pilot position 51 and the second pilot position 52 with respective front view angles can have a collimated visual field, without any error angle, and thus a flight training program toward a multi crew pilot license (MPL) can be provided.

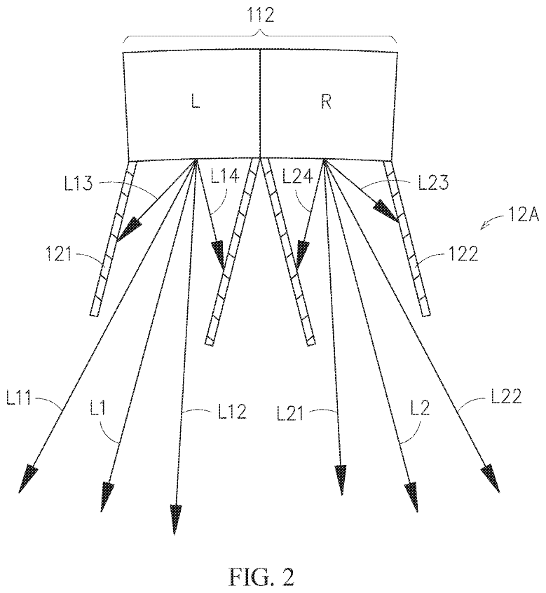

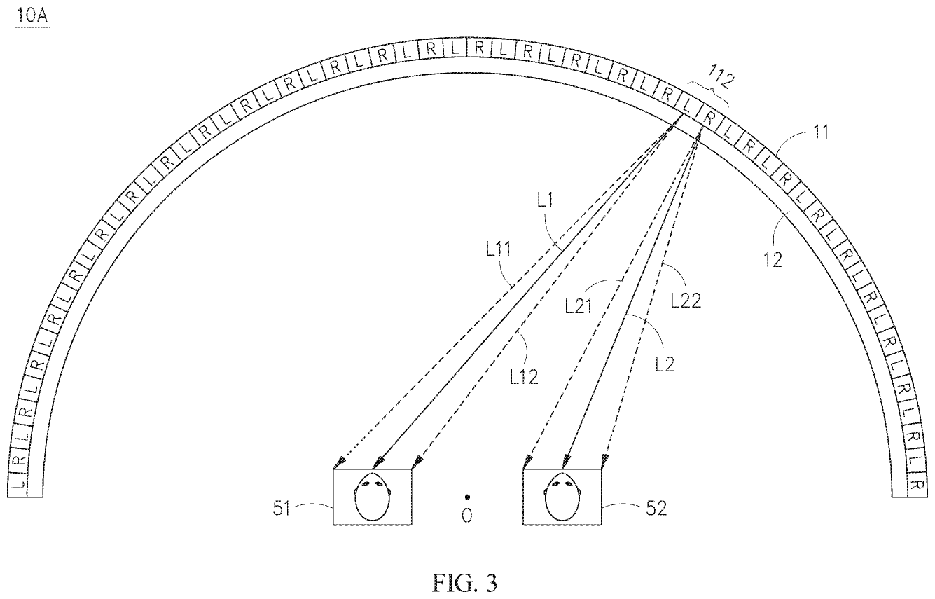

Thus, by providing the optical structure component 12 to separate the light beams from the left sub-pixel L and the light beams from the right sub-pixel R from the same pixel 112, thus corresponding left image L1 and right image L2 generated by the light beams from the left sub-pixel L and the light beams from the right sub-pixel R can be separately provided to the first pilot position 51 and the second pilot position 52, respectively. For example, as shown in FIG. 2 where a schematic view of an embodiment of the optical structure component in accordance with this disclosure is provided, the optical structure component 12A includes reduced angle structures 121, 122, in which the reduced angle structure 121 is disposed to correspond the left sub-pixel L of the pixel 112, while the reduced angle structure 122 is disposed to correspond the right sub-pixel R of the pixel 112. Since the light beams from every pixel 112 are defined with a divergence angle, so the reduced angle structures 121, 122 (a sleeve for example) can be provided with different angles and sizes to limit the divergence angle for the light beams from the left sub-pixel L and that for the light beams from the right sub-pixel R, so as to have the focus range or the divergence angle of the light beams from the left sub-pixel L to be smaller than that of the light beams from the right sub-pixel R, or to have the focus range or the divergence angle of the light beams from the left sub-pixel L to be larger than that of the light beams from the right sub-pixel R. Thereby, with different divergence angles and focus ranges to the light beams from the left sub-pixel L and the light beams from the right sub-pixel R, thus the independence without mutual interference for the light beams can be obtained. As shown in FIG. 2, after the light beams from the left sub-pixel L passes through the corresponding reduced angle structure 121, the divergence angle or the focus range to include the light beams L13, L14 from the left sub-pixel L is larger than the divergence angle or the focus range of the light beams from the right sub-pixel R. Importantly, it is noted that these light beams L13, L14 are blocked by the reduced angle structure 121, and thus won't affect the focus range or the divergence angle of the right sub-pixel R. In FIG. 2 and FIG. 3, the divergence angle or the focus range of the light beams from the left sub-pixel L would be restrained by the light beams L11 and L12 as shown to adjust the position of the left image L1. Similarly, also shown in FIG. 2, after the light beams from the right sub-pixel R passes through the corresponding reduced angle structure 12s, the divergence angle or the focus range to include the light beams L23, L24 from the right sub-pixel R is larger than the divergence angle or the focus range of the light beams from the left sub-pixel L. Importantly, it is noted that these light beams L23, L24 are blocked by the reduced angle structure 122, and thus won't affect the focus range or the divergence angle of the left sub-pixel L. In FIG. 2 and FIG. 3, the divergence angle or the focus range of the light beams from the right sub-pixel R would be restrained by the light beams L21 and L22 as shown to adjust the position of the right image L2. In other words, the optical structure component 12A of this embodiment can narrow the divergence angle of the pixel 112, so that, after the left sub-pixel Land the right sub-pixel R of the same pixel 112 irradiate, the modified divergence angles can have the corresponding left image L1 and right image L2 to be projected to the first pilot position 51 and the second pilot position 52, respectively. Thereupon, the left image L1 and the right image L2 can be independently formed without mutual interference.

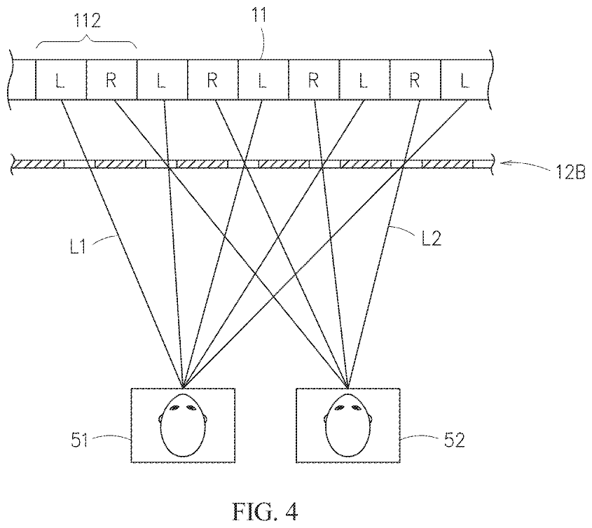

In this disclosure, embodying of the optical structure component is not limited to that 12A shown in FIG. 2. Referring now to FIG. 4, another embodiment of the optical structure component in accordance with this disclosure is schematically shown. In this embodiment, the optical structure component 12B is a barrier-type optical structure. As shown, the optical structure component 12B blocks the right image L2 formed by the light beams from the right sub-pixels R to reach the first pilot position 51. Namely, the image reaching the first pilot position 51 is purely the left image L1 formed by the light beams from the left sub-pixels L, by having the optical structure component 12B to block the right image L2 formed by the light beams from the right sub-pixels R. Similarly, the image reaching the second pilot position 52 is purely the right image L2 formed by the light beams from the right sub-pixels R, by having the optical structure component 12B to block the left image L1 formed by the light beams from the left sub-pixels L. Thereupon, the first pilot position 51 and the second pilot position 52 can receive independently the left image L1 and the right image L2, respectively, without mutual interference.

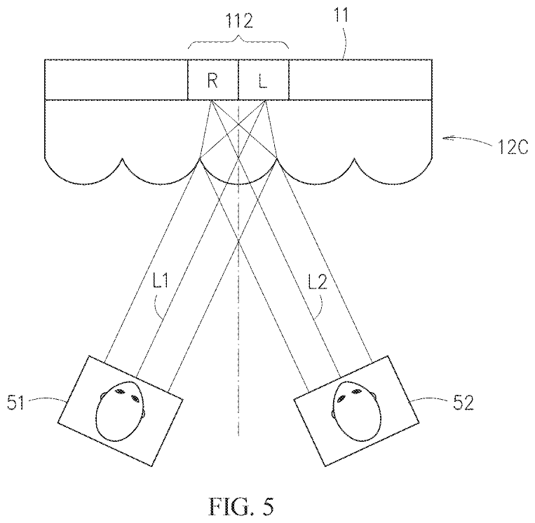

In this disclosure, embodying of the optical structure component is not limited to that 12A shown in FIG. 2 or that 12B in FIG. 4. Referring now to FIG. 5, a further embodiment of the optical structure component in accordance with this disclosure is schematically shown. In this embodiment, the optical structure component 12C is a cylindrical lens structure. As shown, the cylindrical lens structure 12C is used to refract the light beams from the left sub-pixel L and the light beams from the right sub-pixel R from each of the pixels 112. In other words, in this embodiment, through specific arrangements in heights, angles, densities and other micro structures for the cylindrical lens structure 12C, different angling and refracting applied to the light beams from the left sub-pixel L and the light beams from the right sub-pixel R can be achieved. Thereupon, the left image L1 formed by the light beams from the left sub-pixels L can reach the first pilot position 51, while the right image L2 formed by the left beams from the right sub-pixels R can reach the second pilot position 52, in a manner that the left image L1 and the right image L2 are independently and free from mutual interference. In addition, in another embodiment, the optical structure component can be also embodied as a grating-type lens.

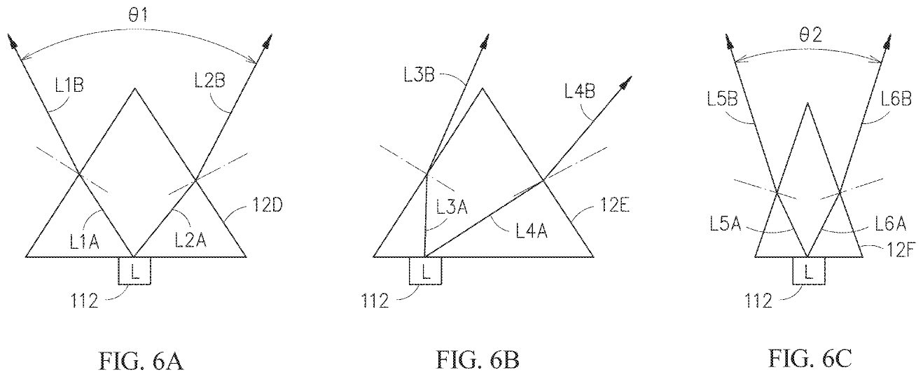

In this disclosure, embodying of the optical structure component is not limited to that 12A shown in FIG. 2, that 12B in FIG. 4, or that 12C in FIG. 5. Referring now to FIG. 6A to FIG. 6C, more embodiments of the optical structure component in accordance with this disclosure are schematically shown. In FIG. 6A, the optical structure component 12D is a prism structure for varying the refraction angles of the light beams from the pixel 112. In particular, after the light beams L1A, L2A from the left sub-pixel L pass through the optical structure component 12D and are refracted while leaving the optical structure component 12D, light beams L1B, L2B are generated accordingly from the light beams L1A, L2A, respectively, in which the angle between the light beams L1B, L2B is θ1. In other words, through the prism structure, refraction angles of the light beams from the left sub-pixel L of each of the pixels 112 can be varied. Similarly, through the prism structure, refraction angles of the light beams from the right sub-pixel R of each of the pixels 112 can be also varied. Thus, in this embodiment, the prism structure is utilized to change the refraction angles of the light beams from the left sub-pixel L and the right sub-pixel R of each pixel 112, and thus to generate accordingly the left image L1 and the right image L2 independently without mutual interference for the first pilot position 51 and the second pilot position 52, respectively. Further, by varying the position of the pixel 112 with respect to the optical structure component 12D, different refraction angles can be obtained. As shown in FIG. 6A, the optical structure component 12D is formed as a triangular pyramid, with the left sub-pixel L disposed at a center of the bottom side of the optical structure component 12D. As shown, in FIG. 6B, the optical structure component 12E is also formed as a prism structure, particularly a triangular pyramid. In other words, the optical structure component 12E of FIG. 6B is largely resembled, in the shape, to the optical structure component 12D of FIG. 6A. In comparison with the left sub-pixel L in FIG. 6A, the left sub-pixel L of the optical structure component 12E of FIG. 6B is disposed at a left-hand-side position with respect to the center of the bottom side of the optical structure component 12E. As shown in FIG. 6B, the light beams L3A, L4A from the left sub-pixel L pass through the optical structure component 12E, and leave the optical structure component 12E as the corresponding light beams L3B, L4B, respectively. Apparently, unlike the light beams L1B, L2B of FIG. 6A after the light beams L1A, L2A leaving the optical structure component 12D, in this embodiment of FIG. 6B where the pixel 112 is adjusted away from a central position, refraction angles of the light beams present a complete different pattern. Further referring to FIG. 6C, the optical structure component 12F is formed as a prism structure having the left sub-pixel L located at a center position of the bottom side of the optical structure component 12F. The major difference in the optical structure component 12F is that an isosceles triangle is applied to the optical structure component 12F. With this difference in shaping the prism structure between the optical structure component 12F of FIG. 6C and that 12D of FIG. 6A, the refraction pattern of the optical structure component 12F of FIG. 6C is typically shown by refracting the light beams L5A, L6A from the left sub-pixel L to the light beams L5B, L6B while the light beams L5A, L5A leaving the optical structure component 12F, in which the light beams L5B, L6B form an angle θ2 which is less than the angle θ1 of FIG. 6A. In other words, by adjusting the shape of the prism structure in accordance with this disclosure, a different divergence angle of the light beams from the sub-pixel would be obtained, and thereupon independent images can be provided to different pilot positions.

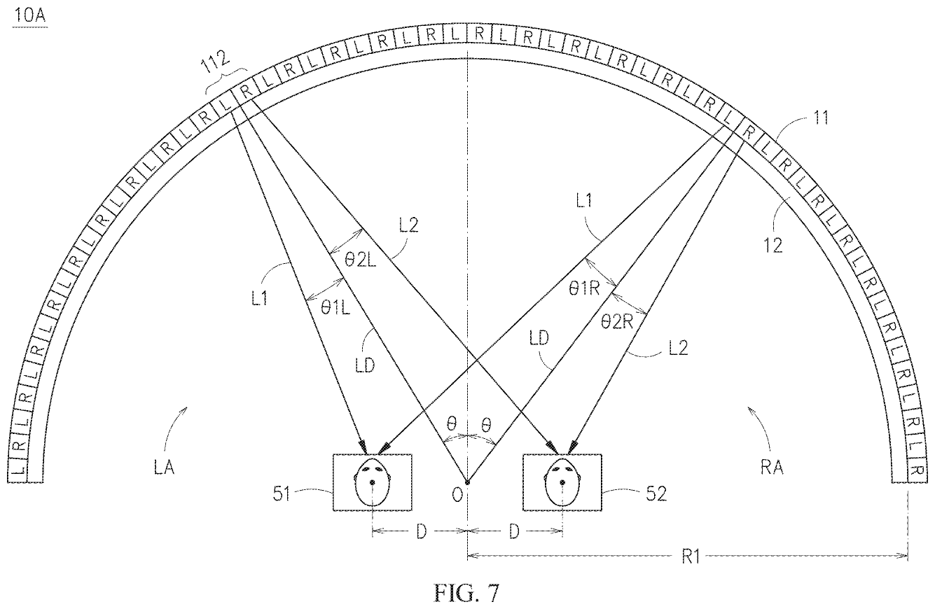

Referring now to FIG. 7, controls of emission angles of the left sub-pixels and the right sub-pixels of FIG. 1 are schematically shown. In FIG. 7, the multi-view display device 10A includes a display screen component 11 and an optical structure component 12, in which the display screen component 11 is formed as a ring screen having a radius R1. By having a radial center-line passing the reference position O as a division line, the display screen component 11 is divided into a left half LA and a right half RA. As shown, the first pilot position 51 is disposed in the left half LA with respect to the reference position O with a distance D between the first pilot position 51 and the reference position O, while the second pilot position 52 is disposed in the right half RA with respect to the reference position O with also the distance D between the second pilot position 52 and the reference position O. An angle θ is defined between the center-line and a connection line from the reference position O to a pixel 112. As shown, the light beam LD from the pixel 112 to the reference position O separates the light beams from the left sub-pixel L and the light beams from the right sub-pixel R, by which the left image L1 and the right image L2 are provided to the first pilot position 51 and the second pilot position 52, respectively. In the right half RA of the display screen component 11, the two independent left image L1 and right image L2 form respective angles θ1R and θ2R with respect to the light beam LD, in which:

θ1R=arctan((R1×sin(θ)+D)/R1×cos(θ))−θ, and

θ2R=θ−arctan((R1×sin(θ)−D)/R1×cos(θ)).

In the left half LA of the display screen component 11, the two independent left image L1 and right image L2 form respective angles θ1L and θ2L with respect to the light beam LD, in which:

θ1L=θ−arctan((R1×sin(θ)−D)/R1×cos(θ)), and

θ2L=arctan((R1×sin(θ)+D)/R1×cos(θ))−θ.

As described, by controlling the emission angle (θ1L+θ2L) or (θ1R+θ2R) formed by the left sub-pixel Land the right sub-pixel R, two independent left image L1 and right image L2 can thus be provided to the first pilot position 51 or the second pilot position 52, respectively.

In some other embodiments, the optical structure component can utilize a polarizer with a dual-angle gradient structure to make the pixels 112 close to the ends of the display screen component 11 have less focusing differences, such that the focus position of the display screen component 11 can be split from the reference position O to the first pilot position 51 and the second pilot position 52. Thereupon, the object of providing the two independent left image L1 and right image L2 to the corresponding first pilot position 51 and second pilot position 52 can be obtained.

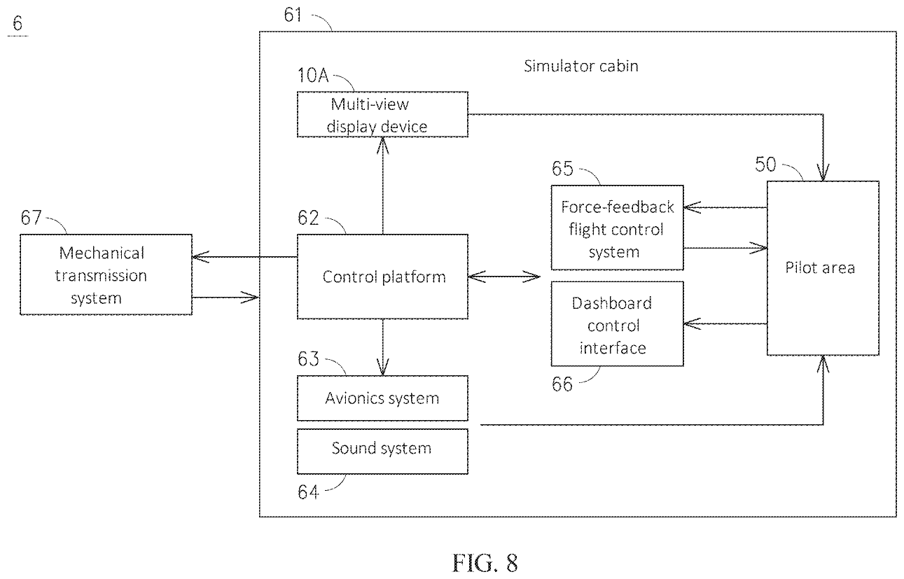

Referring now to FIG. 8, a schematic view of an embodiment of the manipulation simulation device in accordance with this disclosure is shown. In this embodiment, the manipulation simulation device 6, applicable to a plane, a ship, a vehicle or a train, includes a simulator cabin 61, a control platform 62, an avionics system 63, a sound system 64, a force-feedback flight control system 65, a dashboard control interface 66, a mechanical transmission system 67 and the multi-view display device 10A. The control platform 62, the avionics system 63, the sound system 64, the force-feedback flight control system 65, the dashboard control interface 66 and the like cabin hardware are individually disposed inside the simulator cabin 61. Inside the simulator cabin 61, at least one pilot area 50 is included for multiple pilots. In particular, the pilot area 50 can be arranged according to FIG. 1A having two pilot positions, yet this disclosure does not limit this arrangement. In addition, the mechanical transmission system 67 is connected with the simulator cabin 61.

In this embodiment, the manipulation simulation device 6 can be a flight simulator, and the simulator cabin 61 can includes thereinside the avionics system 63, the sound system 64 and the dashboard control interface 66. The avionics system 63 and the sound system 64 are used to output information and audio effects to the pilots, and the pilots can use the dashboard control interface 66 and the force-feedback flight control system 65 to input information or parameters for flight control, and to transmit the input information to the control platform 62. Based on the input information, the control platform 62 transmits output information to the avionics system 63, the sound system 64, the dashboard control interface 66 and the force-feedback flight control system 65, and feedback information would be transmitted back to the pilots via the force-feedback flight control system 65. At the same time, based on the output information, the avionics system 63 and the sound system 64 can input corresponding audios and displays to the pilots. Nevertheless, all the aforesaid details can be adjusted in accordance with practical applications of the manipulation simulation device. In addition, the multi-view display device 10A can be the visual system for the flight simulator able to create visual fields outside the pilot cabin for the pilots, so that a virtual environment with highly fidelity can be provided for flight training.

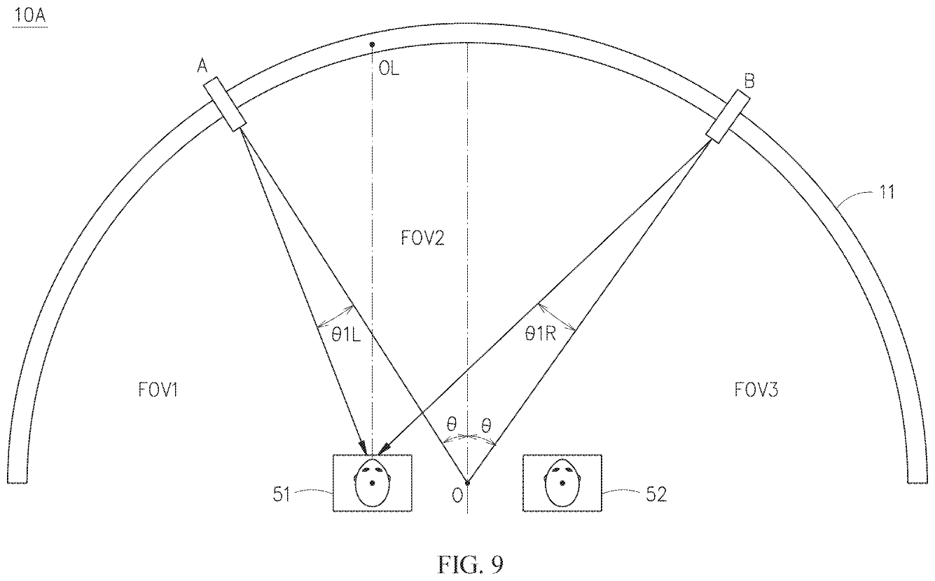

In this embodiment, the control platform 62, disposed in the simulator cabin 61, is connected with the multi-view display device 10A. In the conventional control system of the flight simulator, only a set of image information to multiple pilots is provided, and thus the broader view in the simulator is usually abutted and thereby integrated into a complete set of visual information by a plurality of image information from multiple projectors. Based on practical map information including geometric locations, angles and heights, the control platform 62 can perform transformation into corresponding map having at least one set of image information. The display screen component 11 of the multi-view display device 10A receives at least one image information, independent to each other. Further, the control platform 62 of this disclosure provides each of the trainees (pilots in this embodiment) correct view of the exterior visual fields. Referring now to FIG. 9, a schematic view of an embodiment of the image information in accordance with this disclosure is shown. The multi-view display device 10A has a radial line passing the reference position O as the center-line. In this disclosure, a plurality of positions (say n−1 positions) can be disposed to divide the display screen component 11 into another plurality (n) of fields of visions with respect to the reference position O. In the exemplary example shown in FIG. 9, two positions (n−1=2), a first position A and a second position B, on the display screen component 11 are applied to define three (n=3) fields of visions, a first field of vision FOV1, a second field of vision FOV2 and a third field of vision FOV3, with respect to the reference position O. In this example shown in FIG. 9, the first position A and the second position B are located to opposite sides of the center-line by angling to the center-line and the reference position by an angle θ. In this embodiment, θ=30°.

It shall be explained that the conventional display screen component 11 utilizes several independent computers to perform related calculations firstly and then to form a complete 180° field of vision (FOV) by integrating sectional images (180°/n), particularly referred to the center point. In other words, in the conventional technique, each of the sectional images can only cover a portion of the field of vision (FOV), for example a 60° section similar to the embodiment shown in FIG. 9 of this disclosure. On the other hand, this disclosure evaluates positions of different pilots to adjust the corresponding fields of vision (FOV). Referring to FIG. 9, to the first pilot position 51 at the left hand side, the right front center of the visual field has been shifted left to the left-hand-side position OL. By having the left-hand-side position OL as a new center, for the image in the left half with respect to the left-hand-side position OL, a feasible display width is shorter than that for the image in the right half with respect to the left-hand-side position OL. Thus, to a unit width in the left half with respect to the left-hand-side position OL, more image information is required. Thereupon, the field-of-vision (FOV) value in the left half with respect to the left-hand-side position OL would be increased, while the FOV value in the right half with respect to the left-hand-side position OL is decreased. Of course, the practical FOV value is related to the setup of the radius of the display screen component 11 and the pilot positions. By having the angle calculation for the first independent image provided to the first pilot position 51 as an example, two border points (i.e., the first position A and the second position B) to define the three sections are located at two opposing θ=30° positions with respect to the reference position O. In particular, the first position A and the second position B can be the positions of the pixels 112 as shown in FIG. 7. After calculations, the first field of vision FOV1=60°+θ1L, where θ1L is the angle formed by a line connection the first position A and the first pilot position 51 and another line connecting the first position A and the reference position O; the second field of vision FOV2=60°+θ1R−θ1L, where θ1R is the angle formed by a line connection the second position B and the first pilot position 51 and another line connecting the second position B and the reference position O; and, the third field of vision FOV3=60°−θ1R. Similarly, after calculations for the angling of the second independent image provided to the second pilot position 52, the first field of vision FOV=60°−θ2L, where θ2L is the angle formed by a line connection the first position A and the second pilot position 52 and another line connecting the first position A and the reference position O; the second field of vision FOV=60°+θ1R−θ1L; and, the third field of vision FOV=60°−θ2R, where θ2R is the angle formed by a line connection the second position B and the second pilot position 52 and another line connecting the second position B and the reference position O. It is noted that the aforesaid description upon the embodiment of FIG. 9 is particularly directed to an example of a total FOV=180°. However, to the skill person in the art, he or she shall understand that the aforesaid technique for the exemplary example of the particular total FOV=180° can prevail to other examples for different total FOVs, such as 135°, 225°, 270° and so on.

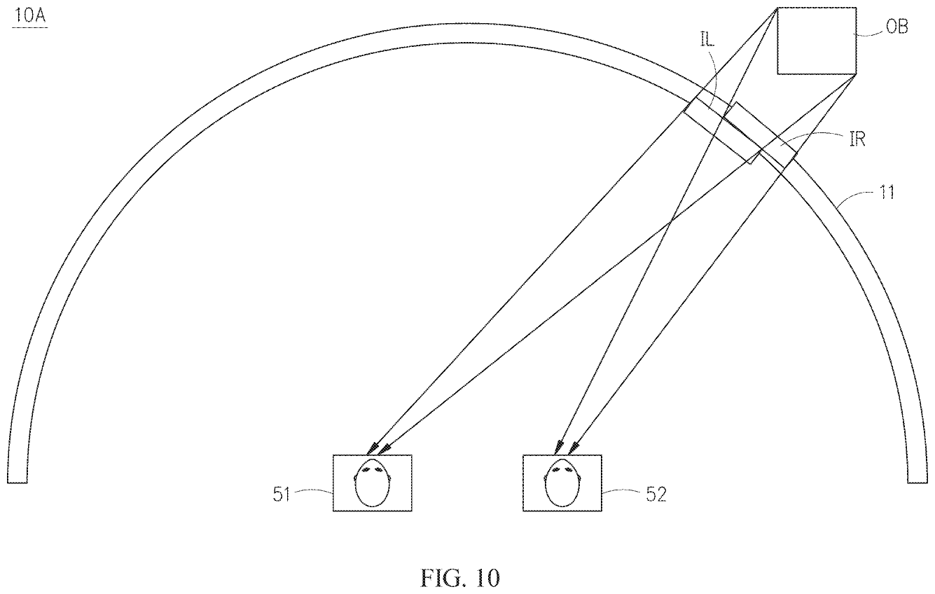

Referring now to FIG. 10, a schematic view of another embodiment of the image information in accordance with this disclosure is shown. This embodiment can be further applied by cooperating image calculations of flight simulation software in the control platform 62. A flow for the image calculations includes the following steps. Firstly, pilot positions, right and left, are defined. Namely, referring to FIG. 10, the first pilot position 51 and the second pilot position 52 are defined firstly. Then, an image of a 3D virtual object OB is focused onto the pilots at the first pilot position 51 and the second pilot position 52, in which the 3D virtual object OB and the mapping portion on the ring screen of the display screen component 11 define the image field on the screen. As shown in FIG. 10, the left image IL is provided to the pilot at the first pilot position 51, and the right image IR is provided to the pilot at the second pilot position 52. In the aforesaid calculations, the practical angling of the screen of the display screen component 11 shall be aligned with the virtual angling by the software calculation, such that each of the pilots can have images with correct angling.

In this embodiment, the control platform 62 is used for providing at least one set of image information to the display screen component 10A. The manipulation simulation device 6 can provide a set, two sets or plural sets of image information to multiple users (i.e., pilots in this embodiment), in which the two sets or the plural sets of image information are mutual independent. Typically, a unique set of image information provides two sets of pixels. Thereupon, this embodiment can provide a set, two sets or plural sets of image information independently without mutual interference. The set of image information can be associated with the multi-view display device 10A of FIG. 1A to generate multiple independent images on the display screen of the same display screen component 11, and each of the independent images is correspondent to different locations at the first pilot position 51 or the second pilot position 52, so that, for the pilots at the first pilot position 51 and the second pilot position 52 to be disposed with different view environments, the same and correct visual field can be observed. In other words, the embodiment in this disclosure can provide different pilots at respective pilot positions with correct exterior visual fields. Thus, the pilots at the first pilot position 51 and the second pilot position 52 can have the same visual field to operate the simulator cabin 61 of the manipulation simulation device 6. Namely, each of the pilots can use the dashboard control interface 66 and the force-feedback flight control system 65 to input the information or parameters for flight control, and transmit the input information to the control platform 62. Then, the control platform 62 would follow the input information to input the output information to the avionics system 63, the sound system 64, the dashboard control interface 66 and the force-feedback flight control system 65, and the force-feedback flight control system 65 would transmit corresponding feedback to the pilots in the pilot area 50. At the same time, the avionics system 63 and the sound system 64 would follow the output information to input corresponding sounds and displays also to the pilots in the pilot area 50. In one embodiment, according to pilot's operating posture, the simulator cabin 61 can be rotated, elevated, descended or shifted by the mechanical transmission system 67. Simultaneously, updated geometric position, angle and height of the simulator cabin 61 would be transformed into image information corresponding to the map by the control platform 62, and then the updated image information would be transmitted to the multi-view display device 10A for displaying in front of the pilots at the first pilot position 51 and the second pilot position 52.

In addition, it shall be explained that the relationship among the multi-view display device 10A, the first pilot position 51 and the second pilot position 52 can be understood by referring to FIG. 1A, FIG. 2 and FIG. 7, where the elements with the same function are assigned with the same numbers. In one embodiment, the multi-view display device 10A can be replaced by the multi-view display device 10B of FIG. 1B, and the optical structure component 12A of FIG. 2 can be replaced by the optical structure component 12B of FIG. 4, the optical structure component 12C of FIG. 5, the optical structure component 12D of FIG. 6A, the optical structure component 12E of FIG. 6B or the optical structure component 12F of FIG. 6C.

In summary, in the manipulation simulation device and multi-view display device provided by this disclosure, an environment with the field of vision (FOV) larger than 180° is created, and the optical structure component is introduced to separate light beams from the left sub-pixel and the right sub-pixel of the same pixel so as to generate the corresponding left image and right image to reach the first pilot position and the second pilot position, respectively. Thereupon, the display screen of the same display screen component can generate multiple independent images without mutual interference. These independent images would be transmitted to different view locations at the first pilot position and the second pilot position, so that pilots at different view locations at the first pilot position and the second pilot position can still have the same visual field, correctly and independently. Hence, different operators or pilots at the first pilot position 51 and the second pilot position 52 with respective front view angles can have a collimated visual field, without any error angle, and thus a flight training program toward a multi crew pilot license (MPL) can be provided.

In addition, the display screen component can be an LED display. Since the LED pixel can have its own light source to control brightness, thus brightness on a specific screen can be controlled for demonstrating significant imaging difference between a target object and the surrounding on the screen so as to simulate a practical event, upon when the target object irradiates bright lights such as sunlight or the like lamp-light. Further, for the LED pixel can provide brighter lights to simulate the glare phenomenon caused by natural lights such as daylights or lamp-lights outside the flight simulator, thus quality images and simulated sun lights can be obtained.

In addition, in this disclosure, since multiple sets of independent image information are provided to pair the multi-view display device, and each of the sets of image information is to organize correct exterior visual fields for different pilots at different pilot positions, thus individual pilots at different pilot position can still have images with the same visual field.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A multi-view display device, applicable to connect a manipulation simulation device including a first pilot position and a second pilot position, comprising:
a display screen component, including a plurality of pixels, each of the plurality of pixels including a left sub-pixel and a right sub-pixel; and
an optical structure component, disposed at the display screen component, wherein, while light beams from the left sub-pixel and light beams from the right sub-pixel of the each of the plurality of pixels pass through the optical structure component, the optical structure component separates the light beams from the left sub-pixel and the light beams from the right sub-pixel so as to generate correspondingly a left image and a right image to reach the first pilot position and the second pilot position, respectively.

2. The multi-view display device of claim 1, wherein the optical structure component is a reduced angle structure for limiting and narrowing a divergence angle of the light beams from the left sub-pixel and another divergence angle of the light beams from the right sub-pixel.

3. The multi-view display device of claim 1, wherein the optical structure component is a barrier-type optical structure for blocking the left image to reach the second pilot position, and for blocking the right image to reach the first pilot position.

4. The multi-view display device of claim 1, wherein the optical structure component is a cylindrical lens structure for refracting the light beams from the left sub-pixel and the right sub-pixel.

5. The multi-view display device of claim 1, wherein the optical structure component is a prism structure for varying a refraction angle of the light beams from the left sub-pixel and another refraction angle of the light beams from the right sub-pixel.

6. The multi-view display device of claim 1, wherein the display screen component includes one of a curved screen, a ring screen and a spherical screen.

7. The multi-view display device of claim 1, wherein the display screen component is one of a curved LED display, an organic LED display, a liquid crystal display and a combination having at least two of the curved LED display, the organic LED display and the liquid crystal display.

8. The multi-view display device of claim 1, wherein the display screen component is a rear projecting device.

9. The multi-view display device of claim 1, wherein the manipulation simulation device is one of a plane, a ship, a vehicle and a train.

10. A manipulation simulation device, comprising:
a simulator cabin, including a pilot area having a first pilot position and a second pilot position;
a control platform, disposed in the simulator cabin, used for providing at least one image information, independent to each other; and
a multi-view display device, connected with the simulator cabin and the control platform, comprising:
a display screen component, including a plurality of pixels, each of the plurality of pixels including a left sub-pixel and a right sub-pixel; and
an optical structure component, disposed at the display screen component, wherein, while light beams from the left sub-pixel and light beams from the right sub-pixel of the each of the plurality of pixels pass through the optical structure component, the optical structure component separates the light beams from the left sub-pixel and the light beams from the right sub-pixel so as to generate correspondingly a left image and a right image to reach the first pilot position and the second pilot position, respectively.

11. The manipulation simulation device of claim 10, wherein the optical structure component is a reduced angle structure for limiting and narrowing a divergence angle of the light beams from the left sub-pixel and another divergence angle of the light beams from the right sub-pixel.

12. The manipulation simulation device of claim 10, wherein the optical structure component is a barrier-type optical structure for blocking the left image to reach the second pilot position, and for blocking the right image to reach the first pilot position.

13. The manipulation simulation device of claim 10, wherein the optical structure component is a cylindrical lens structure for refracting the light beams from the left sub-pixel and the right sub-pixel.

14. The manipulation simulation device of claim 10, wherein the optical structure component is a prism structure for varying a refraction angle of the light beams from the left sub-pixel and another refraction angle of the light beams from the right sub-pixel.

15. The manipulation simulation device of claim 10, wherein the display screen component includes one of a curved screen, a ring screen and a spherical screen.

16. The manipulation simulation device of claim 10, wherein the display screen component is one of a curved LED display, an organic LED display, a liquid crystal display and a combination having at least two of the curved LED display, the organic LED display and the liquid crystal display.

17. The manipulation simulation device of claim 10, wherein the display screen component is a rear projecting device.

18. The manipulation simulation device of claim 10, wherein the manipulation simulation device is one of a plane, a ship, a vehicle and a train.
